(19) United States
(12) Patent Application Publication
(10) Pub. No.: US 2026/0229889 A1
(43) Pub. Date: Aug. 6, 2026

(54) SYSTEM AND METHOD FOR UNPLANNED SEAMLESS MICROGRID ISLANDING

(71) Applicant: AES Clean Energy Services, LLC, Salt Lake City, UT (US)

(72) Inventors: Alston D Costa, Lakewood, CO (US); Ankit Sharma, Longmont, CO (US); Kelsey Horowitz, Louisville, CO (US); Samuel Ley, Boulder, CO (US); Felipe Cantero, Arvada, CO (US)

(73) Assignee: AES Clean Energy Services, LLC, Salt Lake City, UT (US)

(21) Appl. No.: 19/045,073

(22) Filed: Feb. 4, 2025

(51) Int. Cl. H02J 3/00; H02J 3/38

(52) U.S. Cl. CPC H02J 3/0012; H02J 3/381; H02J 3/388

(57) ABSTRACT

A system and method for unplanned seamless microgrid islanding. An islanding breaker may open in an unplanned transition of a plant from grid-tied to islanded. To maintain power to customer loads of the plant, the system and method may use a power plant controller and grid-forming inverters in combination to provide for the seamless and substantially uninterrupted power to the customer loads of the plant in the unplanned transition. For example, upon the islanding breaker islanding, the islanding breaker may send a direct communication, such as via a hardwired electrical connection, to the plant controller indicating that islanding has occurred so that the plant controller is quickly notified of the islanding. After which, the plant controller may generate commands to the grid-forming inverters in order to coordinate the power routed to the microgrid, thereby enabling the seamless and substantially uninterrupted power to the customer loads of the plant.

### FIELD OF THE INVENTION

The present application relates generally to unplanned seamless microgrid transitions, such as an unplanned transition from grid-tied mode to islanded mode, including grid-stability services provided prior to islanding.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

A power grid (interchangeably termed a grid or a macrogrid) is an interconnected network for electricity delivery from producers to consumers. Power grids typically include: power stations (interchangeably a power plant, generating station, or generating plant) that generate power; electrical substations (interchangeably termed substations) that step the voltage up or down; and electrical power distribution where the voltage is stepped down again to the required service voltage(s) for the end customers.

In certain instances, the power grid may work in combination with a microgrid (which may be part of a plant), which may comprise a local electrical grid with defined electrical boundaries that acts as a single and controlled entity. A specific type of microgrid is a stand-alone microgrid, which has its own source of electricity (e.g., generation sources and/or energy storage, such as batteries). The microgrid may operate in different modes of operation, such as grid-tied (interchangeably termed grid-connected) or islanded (interchangeably termed in island mode). A grid-tied microgrid may operate connected to and synchronous with the power grid (e.g., the macrogrid). See US Patent Application Publication No. 2024/0405568 A1, incorporated by reference herein in its entirety.

When the grid becomes unstable, such as due to fluctuations in voltage and/or frequency in the power grid, various actions may be taken. For example, a plant electrically connected to the power grid may provide power to the grid for voltage and/or frequency response, and provide for fault ride through (also known as under-voltage ride through or low voltage ride through). If the grid remains unstable, the islanding breaker may open, thereby disconnecting the microgrid from the power grid. In this way, the islanded microgrid may be electrically disconnected from the power grid and may function autonomously from the power grid with local loads connected in circuit. However, such disconnections from the power grid may result in instability of the microgrid.

### SUMMARY

In one or some embodiments, a method for unplanned transitioning a plant between grid-tied to a power grid and islanded from the power grid is disclosed. The method includes: receiving, by a plant controller, a direct communication from electronics within or associated with at least one islanding breaker indicating that the at least one islanding breaker has islanded the plant from the power grid; responsive to receiving the direct communication, performing by the plant controller: generating, based on power requirements for one or more customer loads of the plant, one or more commands to control grid-forming devices of the plant; and sending the one or more commands to the grid-forming devices; after islanding of the plant and prior to receiving the one or more commands from the plant controller, establishing or maintaining a microgrid by the grid-forming devices independently of one another in order to provide power to the one or more customer loads of the plant; and responsive to receiving the one or more commands from the plant controller, modifying operation of the grid-forming devices to operate in a coordinated manner according to the one or more commands in order to maintain the microgrid to provide the power to the one or more customer loads of the plant.

In one or some embodiments, a plant configured as grid-tied to and islanded from a power grid via at least one islanding breaker and configured for seamless transition from the grid-tied to the islanded. The plant includes: a plant controller comprising: a communication interface; at least one controller; and one or more grid-forming devices. The communication interface is configured to receive a direct communication from electronics within or associated with the at least one islanding breaker indicating that the at least one islanding breaker has islanded the plant from the power grid. The at least one controller is in communication with the communication interface and is configured, responsive to receiving the direct communication, to: determine power requirements for one or more customer loads of the plant; generate one or more commands to control grid-forming devices of the plant; and send the one or more commands to the grid-forming devices. The one or more grid-forming devices are configured to: after islanding of the plant and prior to receiving the one or more commands from the plant controller, establish or maintain a microgrid by the grid-forming devices independently of one another in order to provide power to the one or more customer loads of the plant; and responsive to receiving the one or more commands from the plant controller, modifying operation of the grid-forming devices to operate in a coordinated manner according to the one or more commands in order to maintain the microgrid to provide the power to the one or more customer loads of the plant.

### BRIEF DESCRIPTION OF THE DRAWINGS

The present application is further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIG. 1 is a first block diagram of the power grid, a plant (which includes the microgrid and control electronics), and the islanding breaker.

FIGS. 2A-B are a set of second block diagrams illustrating the sequence of control responsive to an unplanned islanding by the islanding breaker.

FIG. 2C illustrates the islanding breaker opening due to protection at the Point of Interconnection (POI) to the grid crossing protection threshold limits.

FIG. 2D illustrates the PPC sending commands to grid-forming inverters to match load consumption in total to prevent microgrid from collapsing.

FIGS. 3A-C are graphs illustrating pre-and post-islanding of time versus power.

FIG. 4 is a flow chart of control before and after islanding the microgrid.

FIG. 5 is a diagram of an exemplary computer system that may be utilized to implement the methods described herein.

### DETAILED DESCRIPTION OF THE INVENTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about ±10% variation.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

As used herein, terms such as “continual” and “continuous” generally refer to processes which occur repeatedly over time independent of an external trigger to instigate subsequent repetitions. In some instances, continual processes may repeat in real time, having minimal periods of inactivity between repetitions. In some instances, periods of inactivity may be inherent in the continual process.

If there is any conflict in the usages of a word or term in this specification and one or more patent or other documents that may be incorporated herein by reference, the definitions that are consistent with this specification should be adopted for the purposes of understanding this disclosure.

As discussed in the background, the power grid may become unstable, thereby resulting in an islanding breaker opening. The opening of the islanding breaker results in potential disruption of power to local loads, which may depend on different power configuration arrangements. Example power configuration arrangements may comprise the power grid supplying power to the local loads (interchangeably termed customer loads), may comprise the power grid not supplying power to the local loads, and/or may comprise the plant power supplying power to the power grid (e.g., a local plant (interchangeably termed a local power plant) supplying power to the local loads and also electrically connected to the power grid prior to islanding). In particular, prior to islanding, the local plant may operate to electrically interact with one or more parties, including performing one or both of: (i) supplying power to local loads; or (ii) electrically interacting with the power grid, such as supplying power to the power grid and/or receiving power from the power grid. In practice, the local plant may be contracted with the utility to provide frequency and/or voltage regulation and ride-through services. As one example, the local plant may be contracted to dispatch renewable power to the power grid of the utility responsive to the utility dispatching commands requesting renewable power. As another example, the contract may further include the capability to island with local loads (e.g., the local plant is configured to island with its microgrid customer loads, discussed further below).

Further, after islanding, the local plant (via its control electronics) may seek to form and maintain the stability of the microgrid (e.g., voltage within predetermined voltage range and/or frequency within a predetermined frequency range), including providing stable power (e.g., voltage within predetermined voltage range and/or frequency within a predetermined frequency range) to the local loads (e.g., both before and after islanding). Thus, in one or some embodiments, to maintain power to customer loads of the plant, one or more parts of the plant (e.g., the power plant controller and grid-forming inverters, discussed further below) may work in combination to provide for the seamless and substantially uninterrupted power to the customer loads of the plant in the unplanned transition. In this regard, one goal may be to maintain the stable supply of power to the local loads (e.g., as part of forming the stable microgrid) as part of a seamless unplanned transition from grid-tied to islanded.

Various configurations of the local plant supplying power to the local loads are contemplated. As one example configuration, prior to islanding, the local plant may entirely meet the power needs of the local loads (e.g., prior to islanding, the local plant supplies W1 amount of power to the local loads, and the power grid supplies 0 amount of power to the local loads) and the local plant may supply power to the power grid (e.g., for stability of the power grid, the local plant supplies W2 amount of power to the grid). In this regard, the local plant may supply W1+W2 prior to islanding. After islanding, the local power plant may maintain stable power to the local loads (e.g., after islanding, the local plant supplies W1 amount of power to the local loads, with the W1 amount of power supplied via a stable microgrid after islanding).

As a second example configuration, prior to islanding, both the local plant and the power grid may each at least partly supply power to meet the needs of the local loads (e.g., prior to islanding, the local plant supplies X1 amount of power to the local loads and the power grid supplies X2 amount of power to the local loads). After islanding, the local power plant may increase or decrease its amount of power supplied in order to maintain stable power to the local loads (e.g., after islanding, the local plant supplies X1+X2 amount of power to the local loads (compensating for the loss of power from the power grid), with the X1+X2 amount of power supplied via a stable microgrid after islanding.

As a third example configuration, the local plant (prior to islanding, such as immediately prior to islanding) does not supply any power to the local loads; rather, the local loads are powered entirely by the power grid. After islanding, the local plant may be configured to establish and maintain a stable microgrid, with the goal being for the local plant to form the microgrid and to maintain the stable supply of power to the local loads (which previously received power from the power grid) as part of a seamless transition from grid-tied to islanded. Thus, as one of the contemplated various configurations of the local plant supplying power to the local loads, prior to islanding, the power grid may entirely meet the power needs of the local loads (e.g., prior to islanding, the power grid supplies Z amount of power to the local loads, and the local plant supplies 0 amount of power to the local loads). After islanding, the local power plant may maintain stable power to the local loads (e.g., after islanding, the local plant supplies Z amount of power to the local loads, with the Z amount of power supplied via a stable microgrid after islanding). In this regard, the system and method for unplanned seamless islanding may be performed for any one, any combination, or all of the described configurations.

Thus, as discussed above, after islanding, the local plant includes a stable microgrid in which to supply power to the local loads. In one or some embodiments, the stable microgrid is present prior to islanding. Alternatively, a microgrid is not present prior to islanding. For example, depending on the definition of a microgrid, a microgrid may not be present when the local plant is grid-tied (when grid-tied, different parts of the system may be synchronized, including the local loads, the local plant, and part or all of the power grid, so that a microgrid, separate from the power grid, is not present). In either instance, in one or some embodiments, the stable microgrid is present in the islanded local plant.

Thus, in one or some embodiments, the local plant may be configured to operate in any one, any combination, or all of the following four modes of operation: grid-tied, islanded (e.g., with a microgrid); shutdown; and dormant (e.g., de-energized). In this regard, the plant may operate in any one, any combination, or all of the following different modes of operation: grid-tied; islanded; shutdown; or dormant. As discussed above, a grid-tied microgrid may operate electrically connected to and synchronously with the power grid. An islanded microgrid may be electrically disconnected from the power grid and may function autonomously from the power grid with loads connected in circuit. Shutdown may comprise the plant ceasing to generate power. For example, the plant may be placed in the shutdown state for system wide maintenance or due to a grid outage.

However, transitions from grid-tied to islanded may cause problems, particularly where the transition is unplanned. As one example, unplanned transitions from a grid-tied to an islanded mode of operation may involve a momentary loss of power to customer loads (e.g., prior to resuming power from backup generators). In this regard, the customer loads may experience an interruption in power so that the transition from a grid-tied to an islanded mode is not seamless. Further, such a transition may require backup generators that are non-renewable resources to provide the power to the customer loads. In certain instances, customer loads may be large, such as at least 1 MW, which results in a large carbon footprint. Instead, because of the unplanned nature of the transition, little planning may typically be performed in advance, even though after the islanding breaker opens, a stable microgrid (that provides a stable amount of power to the local loads) may need to be established on the order of microseconds (e.g., within at least 100 microseconds, within at least 200 microseconds, within at least 300 microseconds, within at least 400 microseconds, within at least 500 microseconds, etc.). Thus, attempting to automatically perform a seamless islanding transition is difficult. Similarly, attempting to manually establish the stable microgrid after the islanding breaker is opened is impractical, particularly for an unplanned transition. In this regard, unplanned transitions may be particularly difficult to perform in a seamless manner.

One option is to avoid such an “unplanned” transition. As one example, control electronics of the local plant (e.g., a power plant controller (PPC), discussed further below) may analyze the stability of the power grid, such as fluctuations in the voltage and/or frequency of the power grid, and preemptively command the islanding breaker to open, so that the islanding may be planned. However, such preemptive and planned islanding (particularly based on analysis of the stability of the power grid) may itself result in problems. As one example, the PPC may unnecessarily (or prematurely) command the islanding breaker to open. This may result in: (i) additional instability in the power grid (particularly where the local plant is supplying power to the power grid to maintain the power grid's stability); (ii) potentially unnecessary disruptions to the power supplied to the local loads in the transition from grid-tied to islanded; and (iii) potentially unnecessary disruptions to the power supplied to the local loads in the transition from islanded back to grid-tied.

In one or some embodiments, coordination of any one, any combination, or all of the islanding breaker (e.g., the islanding breaker control electronics), the power plant controller (PPC), or the inverter(s) (e.g., the grid-forming inverters) may result in a seamless unplanned islanding transition.

In particular, in one or some embodiments, the islanding breaker may include intelligence (e.g., control electronics that is incorporated within the islanding breaker and/or associated with the islanding breaker) in order to: (1) analyze one or more stability aspects of the power grid; and (2) responsive to analyzing the one or more stability aspects of the power grid, determine to open the islanding breaker (thereby islanding the local loads and the local power plant). For example, the islanding breaker(s) may include protection relays that are configured to trip the islanding breaker(s) depending on the analysis of the one or more stability aspects of the power grid (e.g., responsive to exceeding a protection threshold, such as a voltage protection threshold or a frequency protection threshold, the protection relay may trip the islanding breaker(s)). Various types of analysis of the stability aspects of the grid are contemplated. As one example, the intelligence for the islanding breaker may analyze the voltage of the power grid, such as one or both of whether the voltage on the power grid is within a predetermined voltage range or how much does the voltage on the power grid deviate from the predetermined voltage range. Alternatively, or in addition, the intelligence for the islanding breaker may analyze the frequency of the power grid, such as one or both of whether the frequency on the power grid is within a predetermined frequency range or how much does the frequency on the power grid deviate from the predetermined frequency range. in one particular example, a relay may check whether the rate-of-change-of-frequency (ROCOF) crosses a pre-determined threshold prior to opening the islanding breaker; responsive to determining that the ROCOF) crosses the pre-determined threshold, the islanding breaker is opened. Responsive to the intelligence of the islanding breaker, the intelligence may command the opening of the islanding breaker.

Further, in one or some embodiments, the PPC of the plant, such as the hardware and/or software of the PPC, may be configured for seamless transition. As discussed in more detail below, the islanding breaker (via the islanding breaker control electronics) may directly communicate with the PPC. In one implementation, the direct communication between the islanding breaker and the PPC is via hardwiring. For example, electrical wiring may be routed directly between the islanding breaker control electronics and the PPC. In one particular implementation, auxiliary contact(s) in or associated with the islanding breaker may be hardwired to one or more contacts in or associated with the PPC. In this regard, responsive to the islanding breaker opening, the islanding breaker control electronics may change the state of the auxiliary contact(s) (e.g., an output pin on a respective integrated circuit chip of the islanding breaker control electronics from logic 0 to logic 1 or vice-versa), effectively signaling the opening of the islanding breaker to the PPC (e.g., an input pin on a respective integrated circuit chip of the PPC). Thus, the islanding breaker may send the direct communication via dedicated hardwired line(s) to the PPC (e.g., hardwired from a communication interface of the islanding breaker control electronics that includes output pin(s) on the respective integrated circuit chip of the islanding breaker control electronics to a communication interface of the PPC that includes input pin(s) on the respective integrated circuit chip of the PPC), so that the communication need not even include an address of the PPC. In one or some embodiments, the hardwired connection may be faster than a wireless direct communication. Further, in one or some embodiments, due to the pin-to-pin hardwired connection, the communication (e.g., changing from logic 0 to logic 1 or vice-versa) need not include any address (such as an address of the PPC, which may be included in the wireless direct communication).

Alternatively, or in addition, the islanding breaker may send the direct communication to the PPC, whereby the direct communication labels the PPC as the recipient (e.g., a PPC address) so that the communication is directly sent. Various types of direct communications with the PPC as the recipient are contemplated. As one example, the islanding breaker control electronics may send a wireless communication that includes: (i) the wireless address of the PPC; and (ii) the indication that the islanding breaker has opened. As another example, the islanding breaker control electronics may directly send a communication that includes the address of the PPC, with the PPC receiving the communication without being routed via a router. As still another example, the islanding breaker control electronics may directly send a communication that is routed via the router; though, because the communication includes the address of the PPC, there is no intermediate processing in order to determine which device to route it to.

These direct communications are in contrast to other communications with the PPC, such as via a networked application. In one particular example, other communications may be addressed or directed to the control electronics of the power grid (e.g., such as a control system of the utility that communicates via a supervisory control and data acquisition (SCADA) system architecture), with the control electronics of the utility then analyzing the communications, ultimately forwarding the communications to the PPC. Further, such communications may require a relay (or other such electronics) in order to effectively push the communication to the control electronics of the power grid via a designated protocol. As one example, the islanding breaker control electronics may use the relay in order to conform with a network protocol, such as Modbus, or other type of client-server data communications protocol in order to send an indirect communication to a control system for the utility, in contrast to the direct communication discussed above.

As discussed further below, responsive to the islanding breaker (e.g., as part of its own electronics or electronics associated or working with the islanding breaker) sending a communication via a networking protocol (such as SCADA) to the control system of the utility, the control system of the utility may: process the indirect communication in order to determine that the plant controller is to be notified of that the islanding breaker has islanded the plant; and transmit to the PPC an indication that the islanding breaker has islanded the plant. In one or some embodiments, the indirect communication does not include the address of the plant and/or the address of the PPC. Nevertheless, the control system of the utility may still identify the plant and/or the PPC by accessing a look-up table that correlates islanding breakers with associated plants and/or PPC of the associated plants. By way of example, the indirect communication may identify the specific islanding breaker that sent the indirect communication (e.g., an address of the specific islanding breaker), and using the identity of the specific islanding breaker and the look-up table, determine the address of the plant and/or the address of the PPC of the plant that was islanded as a result of the specific islanding breaker opening. Using the determined address, the control system of the utility may then send a communication that includes the indication that the islanding breaker has opened. Hence, since the content of the communication from the islanding breaker to the control system of the utility is ultimately routed to the PPC, the communication is indirectly routed, via the control system of the utility, and hence considered an indirect communication. Further, the indirect routing of the content of the communication (e.g., the indication that the islanding breaker has opened) necessarily takes longer for the PPC to receive versus the direct communication from the islanding breaker to the PPC.

Alternatively, or in addition to the hardware modification, the software of the PPC may be modified in order to perform one or more actions responsive to receiving the direct communication from the islanding breaker of the islanding. Various actions are contemplated, including any one, any combination, or all of: (i) determining the current power requirements for the microgrid load(s) (e.g., the microgrid customer load(s)); (ii) generating command(s) to send to the grid-forming inverters for controlling the inverters to route power to meet the current power requirements for the microgrid load(s); and (iii) sending the command(s) to the grid-forming inverters.

In one or some embodiments, the inverter(s) may likewise perform one or more operations in order to perform any one, any combination, or all of: before the unplanned seamless transition; during the unplanned seamless transition; or after the unplanned seamless transition. Grid-forming devices (such as grid-forming inverters) may be configured to generate their own stable voltage AC waveform for a respective grid, such as a microgrid. Thus, in one or some embodiments, the plant may include grid-forming inverter(s) (or other types of grid-forming resource(s)) for performing these various tasks. In one instance, the grid-forming devices may be configured to stabilize part or all of the power grid prior to islanding. In particular, the grid-forming devices may be configured to create and hold their own voltage phasor constant while synchronized with the respective grid. Any discussion regarding grid-forming inverters herein may be equally applied to any type of grid-forming resource, such as a power control system (PCS) or the like. In the context of a local microgrid for the plant, the grid-forming inverters may set or establish the voltage or frequency of the respective grid when power is initially supplied to the respective grid and may also autonomously control the respective grid's frequency and voltage in response to one or more grid events, for example, changes in load and/or power supplied to the grid. In this regard, the grid-forming inverters may identify a deviation of voltage and/or frequency at which a part of the respective grid operates and very quickly supplying power to the grid in order to at least partially correct the deviation in voltage and/or frequency at which the grid operates. For example, the grid-forming inverters may be specially programmed to work at the interface between the power resources, such as renewable resources, and the respective grid (e.g., the respective power grid). As one example, the grid-forming inverters may be configured to control the flow of renewable energy into the respective grid quickly and responsively in ways that mimic the control from conventional synchronous generators with electro-mechanical characteristics. Thus, the grid-forming inverters are unlike grid-following inverters (also known as conventional inverters), which depend on the voltage and/or frequency of the grid network to remain synchronized.

In the context of an unplanned islanding, the grid-forming inverters will attempt to establish the grid (such as the microgrid); however, due to the lack of information as to the needs of the microgrid, including the amount of power for the microgrid loads (e.g., the one or more customer loads), while supporting grid-tied dispatch and grid-stability services, the grid-forming inverters may fail without assistance from the PPC (e.g., without the command(s) received by the PPC).

Thus, in one or some embodiments, the inverter(s) may be in grid-forming mode. In one instance, in one or some embodiments, the inverters may always be in grid-forming mode. Alternatively, a trigger event may be the impetus to command the inverter(s) to be put in grid-forming mode to switch from grid-following to grid-forming mode. As one example, responsive to the PPC analyzing the stability of the grid, such as determining that the grid is unstable in one or more aspects (e.g., the PPC analyzes that: the voltage on the power grid is outside of the predetermined voltage range; the voltage on the power grid is outside of the predetermined voltage range by at least a predetermined amount and/or for at least a predetermined amount of time; the frequency on the power grid is outside of the predetermined frequency range; the frequency on the power grid is outside of the predetermined frequency range by at least a predetermined amount and/or for at least a predetermined amount of time; or the rate-of-change-of-frequency (ROCOF) crosses a pre-determined threshold). In either instance, the inverters are in grid forming when the islanding breaker is opened.

Thus, in advance of islanding, various acts may be performed by one or both of: the islanding breaker; or the plant (e.g., the PPC and/or the grid-forming inverters). In one instance, the islanding breaker control electronics may be configured to analyze power on the power grid in order to determine whether to open the islanding breaker. As discussed herein, the islanding breaker control electronics may be configured to analyze one or both of the voltage or the frequency of the power on the power grid in order to determine whether the power on the power grid is excessively unstable, thereby triggering the islanding breaker control electronics to command the opening of the islanding breaker. Various metrics are contemplated in determining whether the power on the power grid is excessively unstable, such as one or both of: (i) whether the voltage on the power grid is outside of an acceptable voltage range for at least a predetermined amount of time; (ii) whether the frequency on the power grid is outside of an acceptable frequency range for at least a predetermined amount of time; or (iii) whether the ROCOF crosses a pre-determined threshold. Further, in one or some embodiments, the plant may perform one or more preparations in advance of the islanding breaker opening depending on its operation. In one instance, prior to the islanding breaker opening, the plant may be operating, such as by injecting power into the power grid to stabilize the power grid (e.g., via the grid-forming inverters). Alternatively, the plant may not be operating or providing power to the power grid. In such an instance, (e.g., in the instance where the plant is not providing power to the grid), the operation of the plant may be modified, such as by commanding the establishment of stable power on a power bus in the plant, effectively in preparation for the future islanding. Further, the inverters may be in grid-forming mode (either based on previous configuration or responsive to a command from the PPC). Thus, in one or some embodiments, analysis may be performed on the plant side (such as by the PPC), with the analysis indicating that the grid is unstable. Given this, the PPC may perform one or both of: modify operation of the inverters (e.g., change the inverters from grid following to grid forming); or modify operation of the plant (e.g., turn the plant on; establish a stable power bus in the plant).

At islanding, the islanding breaker may determine to open itself, thereby islanding the plant from the power grid. Simultaneously (or nearly simultaneously, such as less than 1 second, less than 1/2 second, less than 200 milliseconds, less than 100 milliseconds, less than 50 milliseconds, less than 25 milliseconds), the islanding breaker control electronics (e.g., control electronics included in or associated with the islanding breaker) may send a direct communication to the PPC in the plant, with the communication indicating that the islanding breaker has opened. Concurrently, or thereafter (such as nearly simultaneously, e.g.,, such as less than 1 second, less than 1/2 second, less than 200 milliseconds, less than 100 milliseconds, less than 50 milliseconds, less than 25 milliseconds), the islanding breaker control electronics sends a communication to the utility via the network (e.g., SCADA) indicating that the islanding breaker has opened.

The power requirements, such as the current power requirements, may be determined in one or several ways. In one way, the PPC may determine the power requirements at predetermined intervals, such as periodically or cyclically, independent of any action. In another way, the PPC may determine the power requirements responsive to a predetermined action, such as receipt of and responsive to a communication indicating that the islanding breaker has opened. In either instance, responsive to receiving the communication, the PPC may generate, based on the power requirements of the one or more customer loads, command(s) to send to the grid-forming inverters in order for the grid-forming inverter(s) to meet the current power requirements for the power requirements for the microgrid load(s) of the power plant, and send the command(s) to the grid-forming inverter(s). In one or some embodiments, the PPC may send the command(s) no greater than 500 milliseconds, no greater than 400 milliseconds, no greater than 300 milliseconds, no greater than 200 milliseconds, no greater than 100 milliseconds, no greater than 50 milliseconds, no greater than 40 milliseconds, no greater than 30 milliseconds, no greater than 20 milliseconds, no greater than 10 milliseconds, or no greater than 5 milliseconds from receiving the direct communication from the islanding breaker control electronics.

With regard to a plurality of the grid-forming inverters, responsive to the islanding breaker opening (and before receiving the command(s) from the PPC, which may take no greater than 500 milliseconds), the grid-forming inverters may attempt to form or maintain the microgrid (e.g., one, some, or each grid-forming inverter may attempt to form or maintain the microgrid independently of and/or without communication with other grid-forming inverter(s)). However, the potential changes due to islanding (e.g., prior to islanding, the grid-forming inverters are routing power to the grid) may cause problems in the islanding process. Merely by way of example, the transition from grid tied to islanded may result in the change in the plant dispatching less than half, less than one-quarter, or less than one-tenth of the grid-tied plant dispatch (e.g., the plant may dispatch at least 10 MW (such as at least tens of MWs) when grid-tied and less than 5 MW (such as 1 MW or less) when islanded). In this regard, the unplanned seamless transition may result in a tremendous difference in the dispatch of power by the plant, such as at least an order of magnitude less. Effectively, the grid-forming inverters may need to adjust their output within milliseconds to change in the load consumption from pre-islanding to post-islanding.

For example, the plurality of inverters may not communicate or coordinate with themselves in the islanding process, resulting in potentially wildly varying power contribution from different ones of the plurality of inverters. In particular, one inverter, due to acting independently of other grid-forming inverters, may attempt to inject power to the microgrid at an amount greater than another inverter, potentially leading to excessive power being routed via the one inverter (and potentially leading to tripping of the one inverter) and potentially leading to frequency and/or voltage instability in establishing or maintaining the microgrid. Nevertheless, the time period in which the grid-forming inverters operation in an uncoordinated manner and/or independent manner is limited (until the command(s) from the PPC are received), thereby reducing the potential for the grid-forming inverters to trip in establishing the microgrid.

After the plurality of inverters receive the command(s) sent from the PPC, the plurality of inverters may effectively coordinate their power outputs amongst themselves, potentially resulting in none of the plurality of inverters routing excessing power and resulting in maintaining stability of the microgrid. As such, the coordination of the islanding breaker control electronics (by sending the direct communication to the PPC that indicates to the PPC that the islanding breaker has opened), the PPC (by responding to the direct communication by generating the command(s) to control the grid-forming inverters), and the inverters (by being in grid-forming and by responding to the command(s) sent by the PPC) may result in a seamless unplanned islanding transition. In this regard, coordination of operation of the islanding breaker, the PPC, and the grid-forming inverters may thus result in the seamless transition even in unplanned islanding.

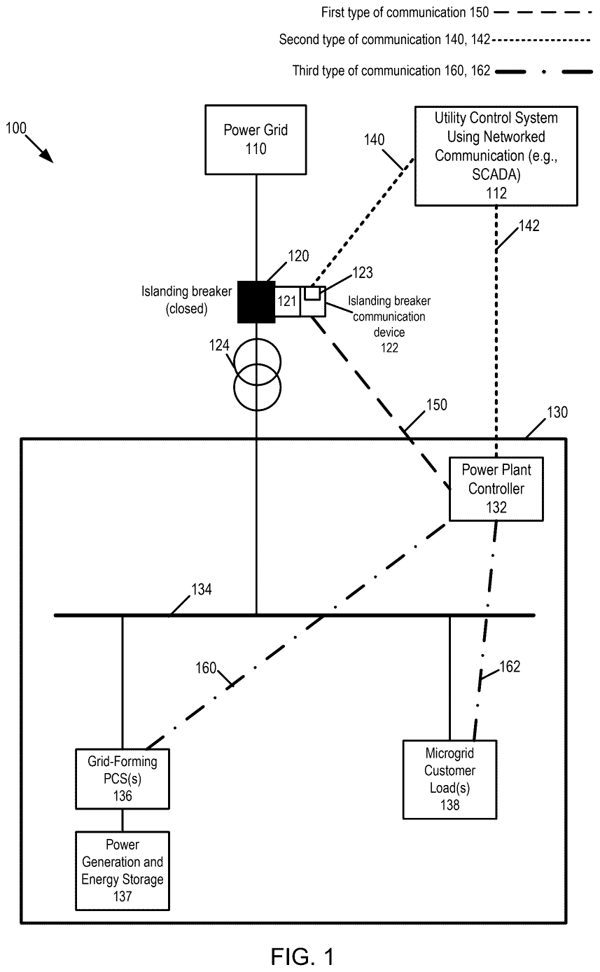

Referring to the figures, FIG. 1 is a first block diagram 100 of the power grid 110, a plant 130 (which may include the microgrid and control electronics, such as the Power Plant Controller (PPC) 132), and the islanding breaker 120. As discussed above, the plant 130 may include power generation, such as power generation and energy storage 137. In one or some embodiments, power generation and energy storage 137 may include renewable power generation, such as solar photovoltaic energy generation or wind renewable energy generation, and/or battery resources, merely by way of examples. In practice, the power generated by power generation and energy storage 137 may be routed via one or more grid-forming devices, such as one or more grid-forming power control systems (PCSs) 136, for power on bus 134, which may be electrically connected to one or both of microgrid customer load(s) 138 or to the power grid 110 (via substation generator step-up (GSU) transformer 124 and islanding breaker 120). In practice, when plant 130 is electrically connected to the power grid 110 (e.g., in grid-tied mode), the plant 130 may supply power to or source power from the power grid 110.

The power grid 110 may be electrically connected to one or more switching devices, such as any one, any combination, or all of breakers, disconnects or reclosers. An example of which is illustrated in FIG. 1 as islanding breaker 120. In practice, islanding breaker 120, when closed, electrically connects at least a part of the plant 130, such as bus 134, to power grid 110. Conversely, the islanding breaker 120, when opened, electrically disconnects the power grid 110 from the plant 130, electrically islanding the plant 130 from the grid. In one or some embodiments, the islanding breaker 120 may include one or more electronic devices included therein and/or associated therewith, such as one or both of islanding breaker control electronics 121 or islanding breaker communication device 122. As discussed above, the islanding breaker control electronics 121 may be configured to perform any one, any combination, or all of:
determine whether to open the islanding breaker 120 (e.g., based on analysis of voltage and/or frequency on the power grid 110); responsive to determining to open the islanding breaker;
open the islanding breaker; and generate one or more communications to transmit via islanding breaker communication device 122. Though depicted in FIG. 1 as separate elements, one or both of islanding breaker control electronics 121 or islanding breaker communication device 122 may be incorporated within islanding breaker 120. Alternatively, one or both of islanding breaker control electronics 121 or islanding breaker communication device 122 may be associated and work in conjunction with islanding breaker 120.

In one or some embodiments, various types of communication are contemplated within first block diagram 100, including any one, any combination, or all of: network communication for data/control within power grid 110 (with utility control system 112 acting as one of (or the sole) control device for control within the power grid 110); network communication for data/control within plant 130 (with power plant controller 132 acting as one of (or the sole) control device for control within the plant 130); and direct communication between islanding breaker 120 (e.g., islanding breaker communication device 122) and power plant controller 132. As one example, network communication for data/control within power grid 110 may use the SCADA architecture for network communication and control (illustrated as second type of communication 140, 142). Likewise, in one embodiment, network communication for data/control within plant 130 may use the SCADA architecture for network communication and control (illustrated as third type of communication 160, 162). This is in contrast to the direct communication (illustrated as first type of communication 150), which is configured to transmit directly between the islanding breaker communication device 122 and power plant controller 132. Thus, the first type of communication 150 may be different from one or both of the second type of communication 140, 142 or the third type of communication 160, 162 in any one, any combination, or all of: (i) how the data is transmitted or collected (e.g., point-to-point versus system wide); (ii) where the data is transmitted (e.g., directly to the end recipient versus to an intermediary or a central repository); or (iii) the ultimate recipient (e.g., to the power plant controller 132 versus to the utility control system 112).

Thus, in one or some embodiments, islanding breaker communication device 122 may send one or more types of communications, such as one or both of a communication via a path for the first type of communication 150 to PPC 132 or a path via the second type of communication 140 to utility control system 112. In one particular example, path via first type of communication 150 may comprise the direct communication path between islanding breaker communication device 122 and PPC 132. Examples of direct communication path may include a hardwired connection between islanding breaker communication device 122 and PPC 132 (e.g., via auxiliary contact(s) in the islanding breaker) or a networked connection that enables the communication (which includes the network address of the PPC 130) to be routed to the PPC. In such an instance, islanding breaker communication device 122 may comprise hardware comprising relay(s), a network interface card, or the like that enables the islanding breaker control electronics 121 to communicate via a network, with the first type of communication 150 being wired (e.g., using Ethernet cables) or wireless (e.g., using radio waves for connections like Wi-Fi, cellular, or the like). For example, islanding breaker communication device 122 may include relay 123 in order to communicate via a networking protocol (e.g., Modbus) with networked communication to communicate with utility control system 112. In this regard, in one embodiment, with the islanding breaker considered as part of the utility infrastructure, the communication is directly from the islanding breaker 122 (as part of the utility infrastructure) to the PPPC 132 (as part of the plant 130). Alternatively, with the islanding breaker considered as part of the plant 130, the communication is directly from the islanding breaker 122 (as part of the plant 130) to the PPPC 132 (as another part of the plant 130).

As shown in FIG. 1, second type of communication 140 is separate from first type of communication 150, and may transmit information via networked communication to utility control system 112 as one form of information flow for the utility to manage the utility power grid. In one particular example, data flow via networked communication to the utility control system 112 may comprise a SCADA architecture for the networked communications, including collecting data (e.g., by automating entire distribution network and facilitating remote monitoring) and managing the power grid 110 (e.g., coordinating, controlling and operating distribution components within the power grid 110). In this context, the islanding breaker communication device 122 may send a communication via second type of communication 140 to utility control system, thereby providing the data via the SCADA architecture to manage the power grid 110. In the context of this management, the utility control system 112, using the SCADA architecture, may send a communication via second type of communication 142 to the PPC 132 notifying the PPC 132 of the opening of the islanding breaker 120. However, because of the indirect nature of the second type of communication 140, 142, and the attendant delay in notifying the PPC 132 of the opening of the islanding breaker 120, the PPC 132 (if the PPC 132 solely relied on the communication from networked communication via utility control system 112) is delayed in controlling and commanding the grid-forming PCSs 136, thereby increasing the potential for a disruptive (instead of seamless) transition. In order to avoid this, the PPC 132 is notified more quickly of the islanding breaker 120 opening via first type of communication 150, thereby triggering the PPC 132 to: (i) determine the current power needs of the microgrid customer load(s) 138 (e.g., by third type of communication 162); (ii) generating the command(s) to control the grid-forming PCSs 136 to form the microgrid; and (iii) sending the command(s) via third type of communication 160 to control the grid-forming PCSs 136 to form the microgrid. In this way, the PPC 132 may more quickly control the grid-forming PCSs 136 for a more stable transition to islanding. In one or some embodiments, the PPC 132 may communicate with the various devices within the plant 130 via the same protocol. In this regard, third type of communication 160, 162 may be the same (e.g., via Ethernet or Wi-Fi). Alternatively, the PPC 132 may communicate with the various devices within the plant 130 via the different protocols. In either instance, the PPC 132 may communicate with the various devices within the plant 130 for the stable creation of the microgrid within the plant. Likewise, after islanding, PCSs 136 may create the microgrid both before and after receiving the command(s) from the PPC 132, as discussed in more detail below.

Separate from the functionality described above, the PPC 132 may be configured to perform one or more other functions in order to manage plant 130, such as any one, any combination, or all of: maintaining batteries (such as battery State of Charge (SoC)) for the plant; managing inverters separate from during islanding (e.g., the PPC 132 may identify a respective inverter going offline, resulting in the PPC 132 commanding redistribution of power to one or more of the remaining grid-forming inverters).

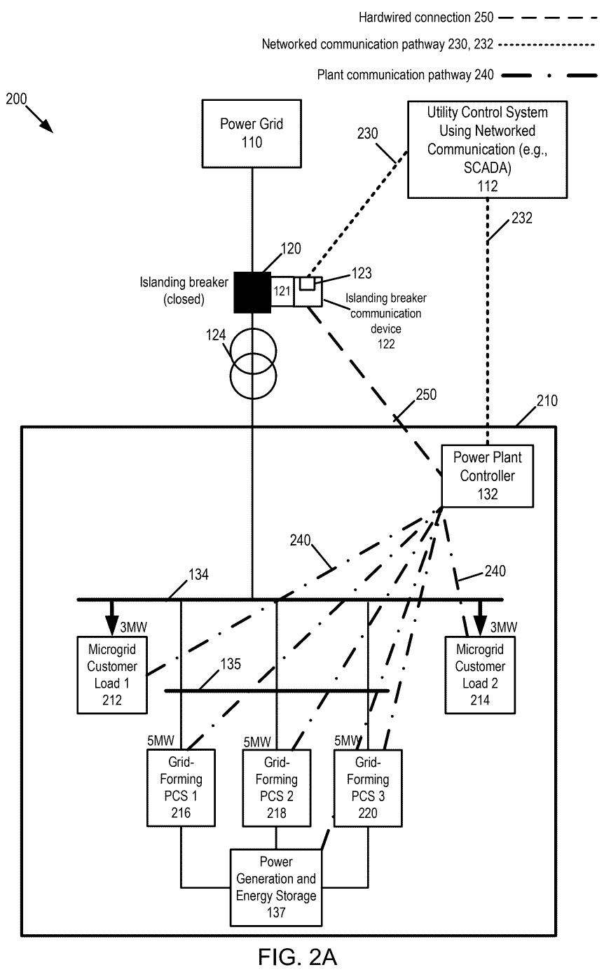

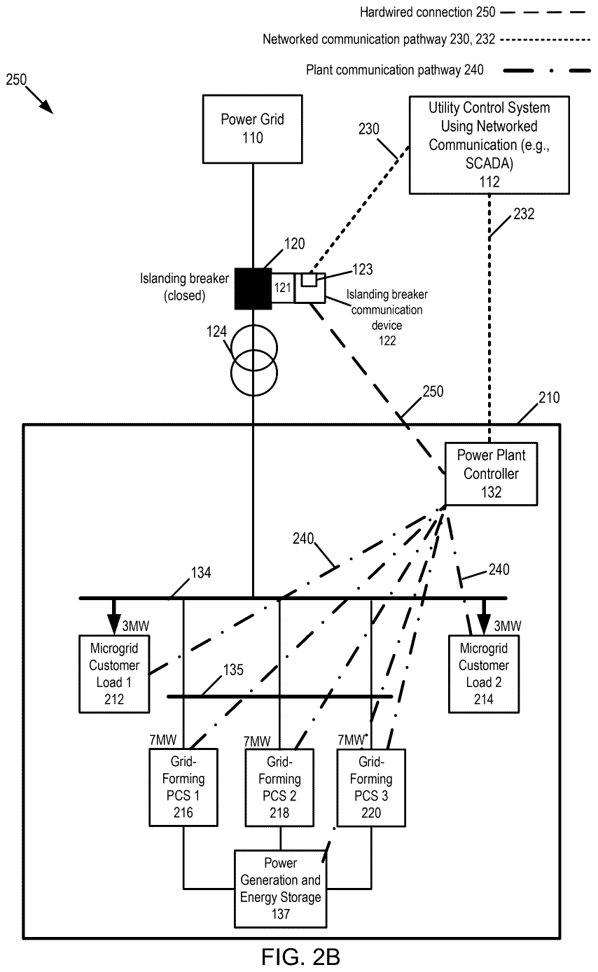

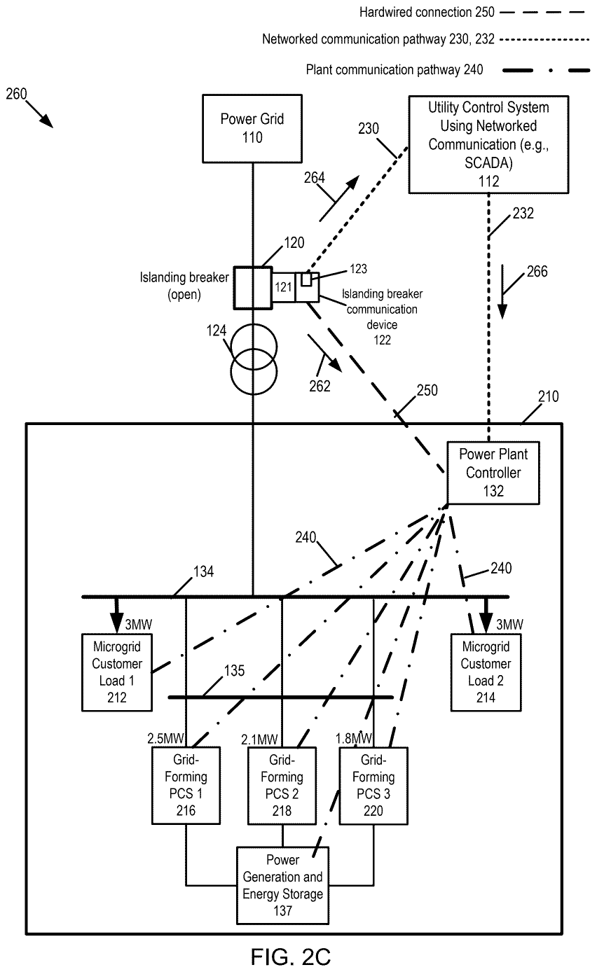

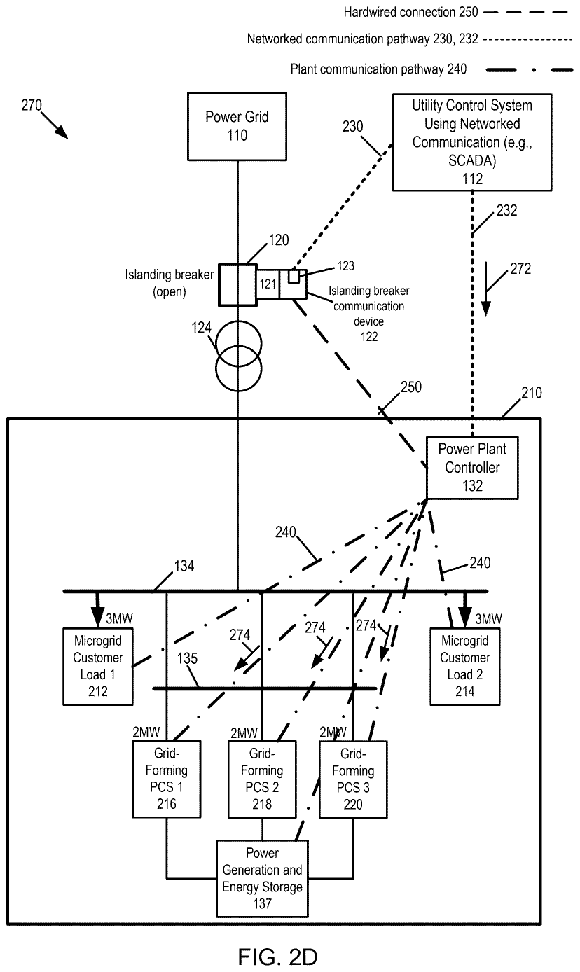

FIGS. 2A-B are a set of second block diagrams 200, 250, 260, 270 illustrating the sequence of control responsive to an unplanned islanding by the islanding breaker 120. FIG. 2A illustrates the plant 210 electrically connected to the power grid 110, with islanding breaker 120 closed. Plant 210 includes one or more loads, such as microgrid customer load 1 (212) and microgrid customer load 2 (214). Plant 210 further includes one or more PCSs, such as grid-forming PCS 1 (216), grid-forming PCS 2 (218), and grid-forming PCS 3 (220). In one or some embodiments, plant 210 may include switchgear 135 (or other common bus) that some or all of the grid-forming PCSs, such as grid-forming PCS 1 (216), grid-forming PCS 2 (218), and grid-forming PCS 3 (220), are connected to. Switchgear 135 may be electrically connected to bus 134, which may comprise a substation bus, which may be controlled or owned by the plant 210 or by the utility.

As shown, microgrid customer load 1 (212) and microgrid customer load 2 (214) are consuming 6 MW of power. Grid-forming PCS 1 (216), grid-forming PCS 2 (218), and grid-forming PCS 3 (220) are each routing the same amount of power (each 5 MW), with 6 MW being routed via bus 134 to microgrid customer load 1 (212) and microgrid customer load 2 (214), and 9 MW being routed via islanding breaker 120 to the power grid 110. Thus, FIG. 2A illustrates the plant 210 in grid-tied mode, with the plant 210 dispatching normally using one or more GFM inverters (such as grid-forming PCS 1 (216), grid-forming PCS 2 (218), and grid-forming PCS 3 (220)) to the power grid 110.

FIG. 2B illustrates the change in operation of the plant 210 when the power grid 110 experiences an electrical fault. In particular, the power grid 110 may have frequency and/or voltage deviations due to an electrical fault on grid network. As a result, the PCSs, such as grid-forming PCS 1 (216), grid-forming PCS 2 (218), and grid-forming PCS 3 (220), may increase the amount of power supplied to the power grid 110 (e.g., increasing from 9 MW to 15 MW, with each PCS routing 7 MW, merely by way of example).

Instability on the power grid 110 may result in different operational changes in the plant 210 in response thereto. In particular, in grid-Tied mode, grid stability services provided by the plant 210 may depend on the nature of grid network fault or conditions (prior to unplanned seamless islanding). In a first instance of a frequency only event where the frequency decreases, the plant 210 may increase active power dispatch into the power grid 110. In a second instance of a frequency only event where the frequency increases, the plant 210 may decrease active power dispatch (e.g., through absorption of power into batteries) into power grid 110. In a third instance of a voltage only event in which the voltage decreases, the plant 210 may increase reactive power dispatch into the power grid 110. In a fourth instance of a voltage only event in which the voltage increases, the plant 210 may decrease reactive power dispatch into grid network. In a fifth instance of a hybrid frequency and voltage event, the plant 210 may increase or decrease active and/or reactive power dispatch into power grid 110 (e.g., priority may be given to either active or reactive power support during event based on utility/off-taker preference).

FIG. 2C illustrates the islanding breaker 120 opening due to protection at the Point of Interconnection (POI) to the grid crossing protection threshold limits (e.g., the islanding breaker control electronics 121 determining the power grid 110 is too unstable). In response to the islanding breaker 120 opening, the PPC 132 receives islanding breaker status (shown as 262) instantaneously through the hardwired connection. Further, the grid-forming inverters may attempt to match load consumption (which is 6MW). This is illustrated as grid-forming PCS 1 (216), grid-forming PCS 2 (218), and grid-forming PCS 3 (220), routing 2.5 MW, 2.1 MW, and 1.8 MW, respectively. Thus, FIG. 2C illustrates that because the grid-forming inverters are not operating in a coordinated manner, the different grid-forming inverters may route different amounts of power (potentially leading to instability in establishing the microgrid).

FIG. 2D illustrates the PPC 132 sending commands to grid-forming inverters to match load consumption in total to prevent microgrid from collapsing. Specifically, via plant communication pathway 240, the PPC 132 may communicate with various devices within plant 130. In this instance, the PPC 132 may send the commands to grid-forming PCS 1 (216), grid-forming PCS 2 (218), and grid-forming PCS 3 (220) (shown as 274) in order to control the grid-forming inverters. As a result of the commands sent, the grid-forming inverters may be controlled to only route power needed to power the loads. For example, each of grid-forming PCS 1 (216), grid-forming PCS 2 (218), and grid-forming PCS 3 (220) (shown as 274) may route 2 MW, thereby meeting the power needs of microgrid customer load 1 (212) and microgrid customer load 2 (214) at a total of 6 MW. Thus, the commands from the PPC 132 may effectively force each of grid-forming PCS 1 (216), grid-forming PCS 2 (218), and grid-forming PCS 3 (220) to the designated 2 MW in order to enable or establish 60 Hz nominal frequency.

In contrast, the utility control system 112 sends a communication (shown as 172) to the PPC 132, indicating the opening of the islanding breaker 120, received much later than the communication (as indicated by 262) sent directly from the islanding breaker 120. In this regard, the PPC 132 is able to control the grid-forming inverters in a timely manner (thereby more quickly establishing the stable microgrid) since the PPC 132 received breaker status instantaneously through hardwired connection (e.g., the grid-forming inverters injecting or absorbing active or reactive power to maintain the designated voltage and frequency of the microgrid).

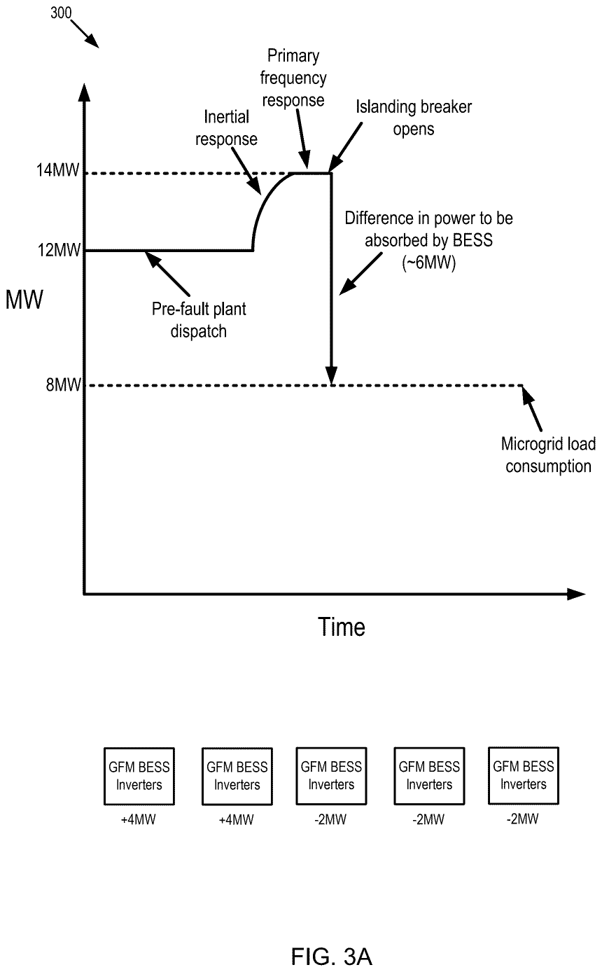

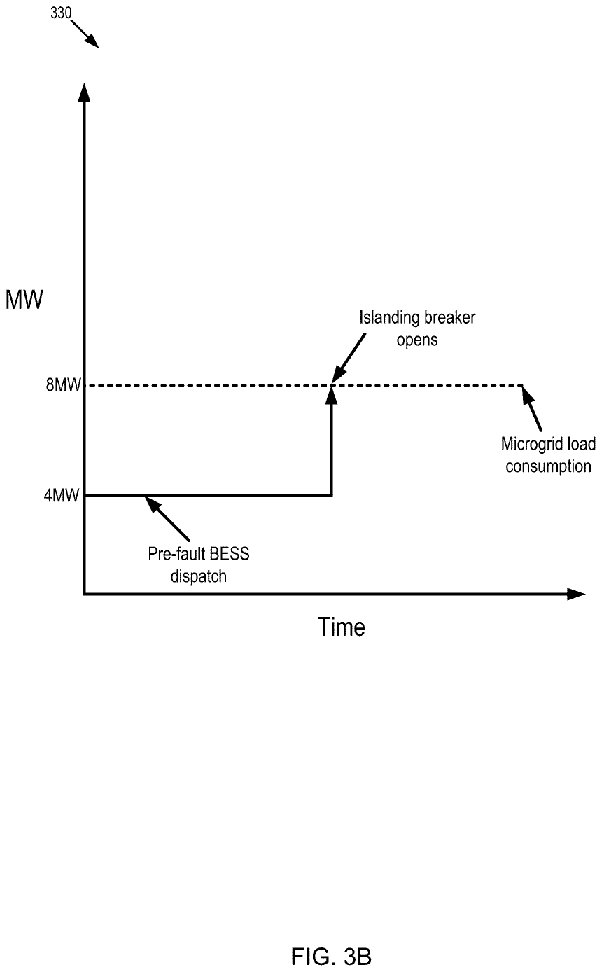

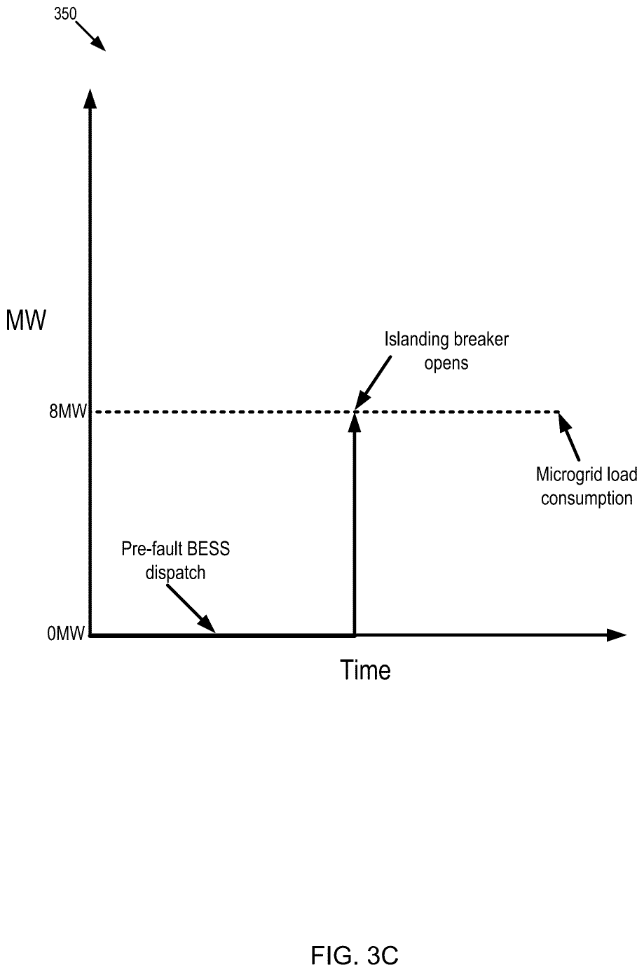

FIGS. 3A-C are graphs illustrating pre-and post-islanding of time versus power. Specifically, FIG. 3A is a graph 300 illustrating, for an under-frequency event in the power grid, the power generated by the plant both before and after islanding. Prior to fault, the plant provides pre-fault plant dispatch, whereby the power plant may include solar generation (e.g., photovoltaics) and a battery energy storage system (BESS). After which, as shown, the plant increases injection of active power (see increase from 12 MW to 14 MW) due to the grid-forming inertial response (which may comprise an exponential curve, as shown in FIG. 3A) and primary frequency response droop (which may comprise a line, as shown in FIG. 3A). Further, grid-forming inverters remain online to provide support to the power grid due to pre-programmed ride-through protection limits (at inverter level). After islanding breaker opens (see islanding disconnection device opens), there is a difference in the power to be absorbed by the BESS (of approximately 6 MW from the 14 MW at opening of the islanding breaker to the 8 MW of microgrid load consumption).

FIG. 3B is a graph 330 illustrating the power generated by the plant both before and after islanding in which the power grid partly, but not entirely, supplies power to the customer loads. As shown, prior to islanding, the plant supplies 4 MW of the 8 MW of microgrid load consumption. At islanding, the plant increases its supply of power from 4 MW to 8 MW, thereby resulting in the seamless transition.

FIG. 3C is a graph 350 illustrating the power generated by the plant both before and after islanding in which the power grid entirely supplies power to the customer loads. As shown, prior to islanding, the plant supplies 0 MW of the 8 MW of microgrid load consumption. At islanding, the plant increases its supply of power from 0 MW to 8 MW, thereby resulting in the seamless transition.

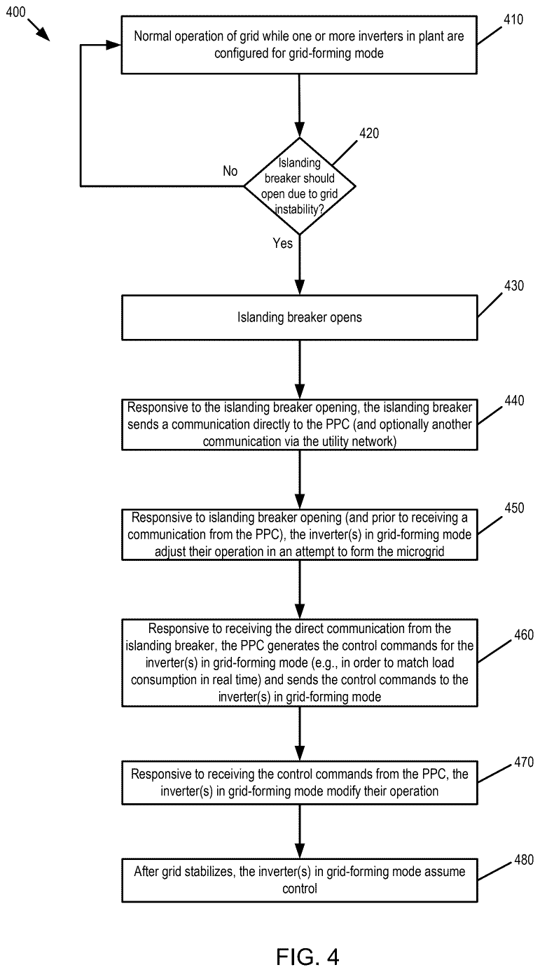

FIG. 4 is a flow chart 400 of control before and after islanding the microgrid. At 410, normal operation of grid is performed while one or more inverters in plant are configured for grid-forming mode (or are permanently in grid-forming mode). At 420, the Islanding breaker determines whether to open due to grid instability. As discussed above, various metrics, such as the power and/or voltage on the power grid, may be analyzed to determine whether the islanding breaker determines to open the breaker. At 430, responsive to the islanding breaker determining to open, the islanding breaker opens. One or more actions may be taken responsive to the islanding breaker opening. For example, responsive to the islanding breaker opening, at 440, the islanding breaker sends a communication directly to the PPC (and optionally another communication via the utility network). At 450, responsive to islanding breaker opening (and prior to receiving a communication from the PPC), the inverter(s) in grid-forming mode may adjust their operation in an attempt to form the microgrid.

At 460, responsive to receiving the direct communication from the islanding breaker, the PPC generates the control commands for the inverter(s) in grid-forming mode (e.g., in order to match load consumption in real time) and sends the control commands to the inverter(s) in grid-forming mode. In one or some embodiments, the control commands may comprise power setpoints. In practice, the grid-forming inverters, within a microgrid setup disconnected from the power grid, may seek to operate in an isochronous mode (e.g., control for the power sources (such as synchronous generators) to maintain a constant frequency). In this regard, the control commands from the PPC may assist the grid-forming inverters in the isochronous mode.

Further, at 470, responsive to the inverter(s) receiving the control commands from the PPC, the inverter(s) in grid-forming mode modify their operation (e.g., to match the output dictated by the command(s) sent from the PPC. After the grid stabilizes, the inverter(s) in grid-forming mode may assume control.

In all practical applications, the present technological advancement must be used in conjunction with a computer, programmed in accordance with the disclosures herein. Generally speaking, various parts may include computing functionality, such as any one, any combination, or all of: the SCADA system; relays; breakers; communication functionality with the utility; or controllers (e.g., PPC). Various types of communication functionality are contemplated. As one example, the communication functionality may comprise Internet communication, wired communication, wireless communication, communication via one or more protocols, etc. Merely by way of example, various devices disclosed in the present application may comprise a computer or may work in combination with a computer (e.g., executed by a computer), such as, for example, in block diagrams in FIGS. 1 and 2A-D, in flow diagram in FIG. 4, and sequence diagrams in FIGS. 3A-C. With regard to the figures, computing functionality may be manifested in any one, any combination, or all of: utility control system 112; islanding breaker control electronics 121; PPC 132; or grid-forming PCSs 136, 216, 218, 220. As such, computing functionality may be resident within any of the electronic devices discussed herein.

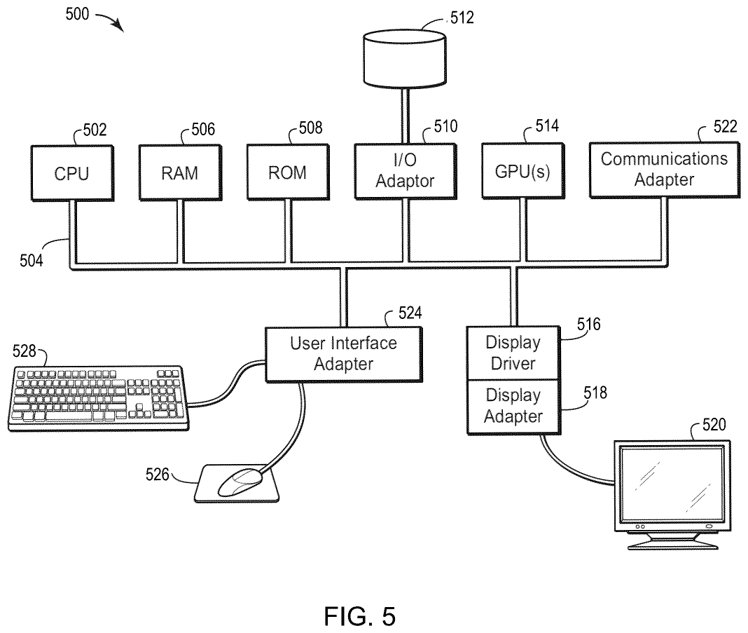

FIG. 5 is a diagram of an exemplary computer system 500 that may be utilized to implement methods, including the flow diagrams, described herein. A central processing unit (CPU) 502 is coupled to system bus 504. The CPU 502 may be any general-purpose CPU, although other types of architectures of CPU 502 (or other components of exemplary computer system 500) may be used as long as CPU 502 (and other components of computer system 500) supports the operations as described herein. Those of ordinary skill in the art will appreciate that, while only a single CPU 502 is shown in FIG. 5, additional CPUs may be present. Moreover, the computer system 500 may comprise a networked, multi-processor computer system that may include a hybrid parallel CPU/GPU system. The CPU 502 may execute the various logical instructions according to various teachings disclosed herein. For example, the CPU 502 may execute machine-level instructions for performing processing according to the operational flow described herein.

The computer system 500 may also include computer components such as non-transitory, computer-readable media. Examples of computer-readable media include computer-readable non-transitory storage media, such as a random-access memory (RAM) 506, which may be SRAM, DRAM, SDRAM, or the like. The computer system 500 may also include additional non-transitory, computer-readable storage media such as a read-only memory (ROM) 508, which may be PROM, EPROM, EEPROM, or the like. RAM 506 and ROM 508 hold user and system data and programs, as is known in the art. In this regard, computer-readable media may comprise executable instructions to perform any one, any combination, or all of the blocks in the flow chart in FIG. 4 and in the sequence diagrams in FIGS. 3A-C. The computer system 500 may also include an input/output (I/O) adapter 510, a graphics processing unit (GPU) 514, a communications adapter 522 (e.g., a communication interface), a user interface adapter 524, a display driver 516, and a display adapter 518.

The I/O adapter 510 may connect additional non-transitory, computer-readable media such as storage device(s) 512, including, for example, a hard drive, a compact disc (CD) drive, a floppy disk drive, a tape drive, and the like to computer system 500. The storage device(s) may be used when RAM 506 is insufficient for the memory requirements associated with storing data for operations of the present techniques. The data storage of the computer system 500 may be used for storing information and/or other data used or generated as disclosed herein. For example, storage device(s) 512 may be used to store configuration information or additional plug-ins in accordance with the present techniques. Further, user interface adapter 524 couples user input devices, such as a keyboard 528, a pointing device 526 and/or output devices to the computer system 500. The display adapter 518 is driven by the CPU 502 to control the display on a display device 520 to, for example, present information to the user such as images generated according to methods described herein.

The architecture of computer system 500 may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” encompasses a hardware processor (such as those found in the hardware devices noted above), ASICs, and VLSI circuits. Input data to the computer system 500 may include various plug-ins and library files. Input data may additionally include configuration information.

It is intended that the foregoing detailed description be understood as an illustration of selected forms that the invention can take and not as a definition of the invention. It is only the following claims, including all equivalents which are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting models discussed herein may be downloaded or saved to computer storage.

What is claimed is:

1. A method for unplanned transitioning a plant between grid-tied to a power grid and islanded from the power grid, the method comprising:
receiving, by a plant controller, a direct communication from electronics within or associated with at least one islanding breaker indicating that the at least one islanding breaker has islanded the plant from the power grid;
responsive to receiving the direct communication, performing by the plant controller:
generating, based on power requirements for one or more customer loads of the plant, one or more commands to control grid-forming devices of the plant; and
sending the one or more commands to the grid-forming devices;
after islanding of the plant and prior to receiving the one or more commands from the plant controller, establishing or maintaining a microgrid by the grid-forming devices independently of one another in order to provide power to the one or more customer loads of the plant; and
responsive to receiving the one or more commands from the plant controller, modifying operation of the grid-forming devices to operate in a coordinated manner according to the one or more commands in order to maintain the microgrid to provide the power to the one or more customer loads of the plant.

2. The method of claim 1, wherein receiving the direct communication from the at least one islanding breaker comprises receiving the direct communication via a hardwired connection between the at least one islanding breaker and the plant controller.

3. The method of claim 2, wherein the direct communication using the hardwired connection via one or more output pins of islanding breaker control electronics being hardwired to one or more input pins of the plant controller.

4. The method of claim 1, wherein the direct communication includes an address of the plant controller.

5. The method of claim 1, further comprising sending an indirect communication indicating that the at least one islanding breaker has islanded the plant, the indirect communication not including an address of the plant controller; and
wherein the plant controller receives the indirect communication after receiving the direct communication.

6. The method of claim 5, wherein the indirect communication is routed to the plant controller via a control system of the power grid.

7. The method of claim 6, wherein the control system:
receives the indirect communication, which does not include the address of the plant controller;
processes the indirect communication in order to determine that the plant controller is to be notified of that the at least one islanding breaker has islanded the plant; and
transmits to the plant controller an indication that the at least one islanding breaker has islanded the plant.

8. The method of claim 7, wherein the control system for the power grid communicates with different parts of the power grid using a supervisor control and data acquisition (SCADA), including receiving the indirect communication and transmitting to the plant controller the indication; and
wherein the plant controller sends the one or more commands to the grid-forming devices using the SCADA architecture.

9. The method of claim 1, wherein the grid-forming devices comprise grid-forming inverters.

10. The method of claim 1, further comprising, prior to islanding, configuring devices as the grid-forming devices.

11. The method of claim 10, further comprising:
analyzing, by the plant controller, power on the power grid;
responsive to the analysis, determining, by the plant controller, to configure the devices as the grid-forming devices; and
responsive to determining to configure the devices as the grid-forming devices, configuring the devices as the grid-forming devices in anticipation of the islanding of the plant.

12. The method of claim 1, wherein the plant includes one or more plant power generation sources;
further comprising, prior to islanding, providing power to the one or more customer loads of the plant, wherein the power provided to the one or more customer loads is at least partly from the one or more plant power generation sources; and
wherein, after the islanding of the plant, the microgrid provides the power to the one or more customer loads entirely from the one or more plant power generation sources.

13. The method of claim 12, wherein, prior to the islanding, the microgrid provides the power to the one or more customer loads entirely from the one or more plant power generation sources;
wherein, after the islanding and before the grid-forming devices receive the one or more commands from the plant controller, the grid-forming devices control flow of the power from the one or more plant power generation sources to entirely provide the power to the one or more customer loads; and
wherein, after the grid-forming devices receive the one or more commands from the plant controller, the grid-forming devices modify the control of the flow of the power from the one or more plant power generation sources to entirely provide the power to the one or more customer loads in order to balance the flow amongst the grid-forming devices.

14. A plant configured as grid-tied to and islanded from a power grid via at least one islanding breaker and configured for seamless transition from the grid-tied to the islanded, the plant comprising:
a plant controller comprising:
a communication interface configured to receive a direct communication from electronics within or associated with the at least one islanding breaker indicating that the at least one islanding breaker has islanded the plant from the power grid; and
at least one controller in communication with the communication interface, the at least one controller configured, responsive to receiving the direct communication, to:
determine power requirements for one or more customer loads of the plant;
generate one or more commands to control grid-forming devices of the plant; and
send the one or more commands to the grid-forming devices;
the one or more grid-forming devices configured to:
after islanding of the plant and prior to receiving the one or more commands from the plant controller, establish or maintain a microgrid by the grid-forming devices independently of one another in order to provide power to the one or more customer loads of the plant; and
responsive to receiving the one or more commands from the plant controller, modifying operation of the grid-forming devices to operate in a coordinated manner according to the one or more commands in order to maintain the microgrid to provide the power to the one or more customer loads of the plant.

15. The plant of claim 14, wherein the at least one communication interface comprises a hardwired connection through which to receive the direct communication from the at least one islanding breaker.

16. The plant of claim 15, wherein the communication interface comprise one or more input pins hardwired to one or more output pins of at least one islanding breaker control electronics.

17. The plant of claim 14, wherein the at least one communication interface is configured to receive the direct communication including an address of the plant controller.

18. The plant of claim 14, wherein the at least one communication interface is further configured to receive an indirect communication indicating that the at least one islanding breaker has islanded the plant, the indirect communication not including an address of the plant controller; and
wherein the plant controller is configured to receive the indirect communication after receiving the direct communication.

19. The plant of claim 1, further comprising one or more plant power generation sources;
wherein the plant controller is further configured to:
prior to islanding, control routing power to the one or more customer loads of the plant, wherein the power provided to the one or more customer loads is at least partly from the one or more plant power generation sources; and
after the islanding of the plant, control the microgrid to provide the power to the one or more customer loads entirely from the one or more plant power generation sources.

20. The plant of claim 19, wherein the plant controller is configured to prior to the islanding, control the microgrid to provide the power to the one or more customer loads entirely from the one or more plant power generation sources;
wherein, after the islanding and before the grid-forming devices receive the one or more commands from the plant controller, the grid-forming devices are configured to control flow of the power from the one or more plant power generation sources to entirely provide the power to the one or more customer loads; and
wherein, after the grid-forming devices receive the one or more commands from the plant controller, the grid-forming devices are configured to modify the control of the flow of the power from the one or more plant power generation sources to entirely provide the power to the one or more customer loads in order to balance the flow amongst the grid-forming devices.
